(19) United States
(12) Patent Application Publication
(10) Pub. No.: US 2024/0195644 A1
(43) Pub. Date: Jun. 13, 2024

(54) METHOD FOR PROCESSING A REQUEST TO ACTIVATE AT LEAST ONE INTERFACE OF AN ITEM OF HOST EQUIPMENT WITH AT LEAST ONE LOCAL AREA COMMUNICATION NETWORK MANAGED BY THE HOST EQUIPMENT, METHOD FOR REQUESTING ACTIVATION OF THE AT LEAST ONE INTERFACE AND CORRESPONDING DEVICES, HOST EQUIPMENT, TERMINAL EQUIPMENT, MANAGEMENT SYSTEM AND COMPUTER PROGRAMS

(71) Applicant: Orange, Issy-Les-Moulineaux (FR)

(72) Inventors: Philippe DUSSAUME, Chatillon Cedex (FR); Jean-Philippe JAVAUDIN, Chatillon Cedex (FR); Jean-Michel BONNAMY, Chatillon Cedex (FR)

(21) Appl. No.: 18/556,336

(22) PCT Filed: Apr. 15, 2022
(86) PCT No.: PCT/FR2022/050723

§ 371 Date: Oct. 19, 2023

(30) Foreign Application Priority Data
Apr. 19, 2021 (FR) 2104041

(51) Int. Cl. H04L 12/12; H04L 12/46

(52) U.S. Cl. CPC H04L 12/12; H04L 12/46

(57) ABSTRACT

A method for processing a request to activate at least one interface of an item of host equipment with a first local area communication network managed by the item of host equipment, the item of host equipment and the interface being in standby mode. The method implementing: receiving from an item of terminal equipment of an application message requesting activation of the interface of the first network on an interface that has remained active of the item of host equipment with a second local area communication network; verifying that the item of terminal equipment is authorized to access the at least one first network based on an address, called second address, of the item of terminal equipment for the second network and, when the item of terminal equipment is authorized to access the at least one first network, activating the at least one interface of the first network.

### CROSS-REFERENCE TO RELATED APPLICATIONS

This application is filed under 35 U.S.C. § 371 as the U.S. National Phase of Application No. PCT/FR2022/050723 entitled “METHOD FOR PROCESSING A REQUEST TO ACTIVATE AT LEAST ONE INTERFACE OF A HOST EQUIPMENT WITH AT LEAST ONE LOCAL AREA COMMUNICATION NETWORK MANAGED BY SAID HOST EQUIPMENT, METHOD FOR REQUESTING ACTIVATION OF SAID AT LEAST ONE INTERFACE, AND CORRESPONDING DEVICES, HOST EQUIPMENT. TERMINAL EQUIPMENT, MANAGEMENT SYSTEM AND COMPUTER PROGRAMS” and filed Apr. 15, 2022, and which claims priority to FR 2104041 filed Apr. 19, 2021, each of which is incorporated by reference in its entirety.

### BACKGROUND

### Technical Field

The field of the development is that of a home or office local area communication network, to which terminal equipment connects. The local area communication network is managed by an item of host equipment, for example a home or office gateway. In particular, the development relates to the access to this local area network by an item of terminal equipment when the item of host equipment and its interfaces with this local area network are in standby mode.

### Prior Art

While the Internet of Things tends to impact all aspects of daily and professional life, citizens are increasingly concerned about the future of the planet. This concern leads them to reduce the waste of energy resources.

In the connected home or office, energy consumption can be reduced by stopping or placing in a standby mode equipment that is not in use, or at least some of its components, applications or interfaces. This is the case, for example, when the inhabitants of a house are away on holiday. Today, a group of items of equipment can be remotely stopped and restarted using a common power socket with a 3G/4G control interface. However, it is still difficult to achieve flexible management and use of this equipment by this means. In any case, this management cannot be automated.

In order to allow equipment to remain in a standby mode but to be woken up at any time, either at the request of a user or automatically, it is also known, on Ethernet networks, to send a wake-up packet to the IP address of the gateway or host equipment that manages the local area communication network, this packet mentioning the MAC address of the item of equipment to be woken up.

When the interfaces of the item of host equipment with the local network, for example of the Wi-Fi type, are in standby mode, a known solution consists in using a specific radio device dedicated to listening on one of the specific radio frequency channels of the Wi-Fi and responsible for waking up the Wi-Fi interface of the gateway when it receives a particular signal. However, this solution has the disadvantage of requiring the integration of an additional component in the gateways, and for this reason it has not been adopted by the market.

A mechanism for transferring a Bluetooth session to Wi-Fi is also known, but it is not applicable here because it requires the Wi-Fi interface to remain active.

There is therefore a need for a solution to enable an item of terminal equipment to access the local network of an item of host equipment when the latter is in standby mode. To have a chance of being adopted by the market, this solution must be simple, secure and based on well-known telecommunications protocols that are already deployed.

### SUMMARY

The development improves the situation.

The development responds to this need by proposing a method for processing a request to activate at least one interface of an item of host equipment with a first local area communication network managed by said item of host equipment, said item of host equipment and said at least one interface being in standby mode.

Said method implements:
receiving from an item of terminal equipment of an application message requesting activation of said interface of said item of host equipment with the first network on another interface, that has remained active, of said item of host equipment with a second local area communication network;
verifying that the item of terminal equipment is authorised to access said at least one first network based on an address, called second address, of the item of terminal equipment for the second network and,
when the item of terminal equipment is authorised to access said at least one first network, activating said at least one interface of the first network.

The development thus proposes a completely new and inventive approach, which consists in activating a first network of an item of host equipment in standby mode, on reception from an item of terminal equipment of an application message requesting activation of an interface with this first network on a second local network whose interface with the item of host equipment has remained active. This activation is carried out once it has been verified that the item of terminal equipment is authorised to connect to the first network. For example, the first local network is a high-speed, high power consumption network, for example based on Wi-Fi or Ethernet technology, while the second network is a low-speed, low power consumption network, for example based on BLE (Bluetooth Low Energy) technology.

It is to be noted that the second network can also be based on direct communication between 5G terminals, for example smartphones or connected objects compatible with the 3GPP 5G standard, that is without passing through the intermediary of a base station.

Thus, with the development, an item of terminal equipment wishing to connect to the local network of an item of host equipment, whose hardware and software components managing it are inactive, can control the wakening of this local network by sending application messages to this host via other communication interfaces.

In this way, it is possible to put the most energy-consuming hardware and software components of this network on standby, while keeping an interface active with another, more energy-efficient local network, for example a low-speed network, so as to enable a high-speed local network to be woken up when a terminal equipment authorised to connect to it needs to do so.

The development has the advantage of being based on existing hardware components, while involving the application level in a specific way.

According to one aspect of the development, said verification comprises consulting a table stored in memory, said item of terminal equipment being authorised to access said first local network, when said table associates at least with said second address of the item of terminal equipment for the second local network a first address of the item of terminal equipment for the first local network.

This verification is based on a locally stored table, for example organised as a persistent database. As a minimum, it is verified that the table includes a link address, for example a MAC address, of the item of terminal equipment in the first network of which it requests the activation of the interfaces.

According to another aspect of the development, said verification includes verifying that the activation request has been received within an authorised time slot.

One advantage is that the first network can only be activated during certain time slots, such as office hours, with night-time hours prohibited to limit the risk of intrusion by hackers.

According to yet another aspect, the reception comprises obtaining an item of information indicating that the action requested is the activation of the first local network, said item of information being included in said message.

In this embodiment, the wake-up message is explicit. For example, the item of information in question is a sequence of characters that can be interpreted by the item of host equipment as a wake-up action of the first local network. In another example, the item of information comprises the first host equipment address for the first local network to wake up.

Alternatively, the wake-up message can be implicit. For example, the simple reception of a data packet with no payload on the second network is considered as a request to activate an interface of the item of host equipment with the first network, or with other available local networks if necessary.

According to yet another aspect of the development, the reception comprises obtaining at least one item of information identifying a service performed by the item of terminal equipment, said item of information being included in said message, and the verification comprises verifying that the service is authorised.

For example, the service invoked is the sending of image or video files to a remote server address (cloud) via the first network and the item of host equipment which has access to the remote network (Internet). This information can also identify the item of terminal equipment application that implements this service.

In yet another aspect of the development, where the item of host equipment comprises an interface with a wide area communication network, the method comprises determining from the service identifier other network interfaces to activate for implementing the service, and activating said other network interfaces.

Advantageously, details of the service can be obtained by interrogating a service orchestrator, available at the item of host equipment.

For example, if the service identified is the regular sending of image or video files captured by a surveillance camera to an address in the cloud, the service requires access to a remote network to send its image files to the remote server.

The development allows to trigger activation of the item of host equipment interface with the WAN network. The camera can then either send its file directly to the cloud using connection information it has in memory, or use an intermediary, for example a service orchestrator implemented by the item of host equipment configured to connect itself to the cloud and send the file to it.

According to another aspect of the development, following activation of said at least one interface with the first network, on reception of a connection request to the first network from the item of terminal equipment on said interface, said connection request comprising at least one first address of the item of terminal equipment on the first network and information for connecting the item of terminal equipment to the first network, the method comprises:
verifying that the first address received from the item of terminal equipment for the first network is associated in said table with the second address of the item of terminal equipment for the second network, and
when said verification is positive, connecting the item of terminal equipment to the first network using the connection information.

Security is based at least on a filtering of the second address of the item of terminal equipment in the second network.

According to another aspect of the development, said activation request message comprising a session token of the item of terminal equipment on the first network, said verification comprises a comparison of said received session token with a session token stored in said table in association with the identifier of the item of terminal equipment and a validation of the received token when it is identical to the stored session token.

One advantage is that the item of host equipment uses this session token as a temporary key common to the item of terminal equipment, enabling it to ensure that the network address of the item of terminal equipment on the second network is not usurped.

This session token may be derived from a previous communication from the item of terminal equipment in the item of host equipment's second network, or it may be a temporary single-use token created by the host terminal equipment and the item of terminal equipment each using a same algorithm and producing a series, for example. For example, this series is initiated by the user on both the item of terminal equipment and the item of host equipment at the time of an initial configuration. This configuration can be the subject of an ad hoc application exchange between the two parties.

According to yet another aspect of the development, the method comprises obtaining information relating to a context of a previous communication session on the first network from the session token and verifying that a time counter associated with said context has not expired and, when the time counter has not expired, connecting to the first network comprises recovering said session context from the information obtained.

One advantage is that it allows rapid reconnection to the first network without jeopardising the security of that network. Due to the time counter, a new connection session context is created regularly.

According to yet another aspect of the development, the activation request having been received on a first and a second interface with the second network, the method comprises determining a power measurement of a signal received on the first and second interfaces and selecting an interface of the item of host equipment to activate for the first network among a first and a second available interfaces, the selected interface being associated with the one with the second network corresponding to the highest power measurement.

When several interfaces of the first and second networks are available at the item of host equipment, the development proposes to choose to activate for the first network the one that is associated with the one of the second network that has received the strongest signal.

The development also relates to a computer program product comprising program code instructions for implementing a processing method according to the development, as described previously, when it is executed by a processor.

The development also relates to a computer-readable storage medium on which the computer programs as described above are recorded.

Such a storage medium can be any entity or device able to store the program. For example, the medium can comprise a storage means, such as a ROM, for example a CD-ROM or a microelectronic circuit ROM, or a magnetic recording means, for example a USB drive or a hard drive.

On the other hand, such a storage medium can be a transmissible medium such as an electrical or optical signal, that can be forwarded via an electrical or optical cable, by radio or by other means, so that the computer program contained therein can be executed remotely. The program according to the development can be in particular downloaded on a network, for example the Internet network.

Alternatively, the storage medium can be an integrated circuit in which the program is embedded, the circuit being adapted to execute or to be used in the execution of the above-mentioned processing method.

The development also relates to a device for processing a request to activate at least one interface of an item of host equipment with a first local area communication network managed by said item of host equipment, said item of host equipment and said at least one interface being in standby mode.

Said device is configured to implement:
receiving from an item of terminal equipment of an application message requesting activation of said interface of the item of host equipment with the first network on an interface that has remained active of the item of host equipment with a second local area communication network;
verifying that the item of terminal equipment is authorised to access said at least one first network from an address, called second address, of the item of terminal equipment on the second network, and
when the item of terminal equipment is authorised to access said at least one first network, activating said at least one interface of the first network.

Advantageously, said device is configured to implement the above-mentioned processing method, according to its different embodiments.

Advantageously, said device is integrated into the item of host equipment.

Correlatively, the development also relates to a method for requesting activation of at least one interface of an item of host equipment with a first local area communication network managed by said item of host equipment, said item of host equipment and said at least one interface being in standby mode.

Said method is implemented by an item of terminal equipment and comprises:
sending to the item of host equipment an application message requesting activation of said at least one interface of the first network on an interface that has remained active of the item of host equipment with a second local area communication network;
upon detection of the first network, issuing a connection request to said interface; and
executing a service using said connection to the first network.

The development thus enables authorised terminal equipment to activate a standby local area network while it executes a service for which it is responsible.

According to one aspect of the development, the method comprises a search for the first network of the item of host equipment and it triggers the sending of an application message requesting activation of an interface of the first network of the item of host equipment on the second network in the absence of detection of said first network.

One advantage is that the activation request is only transmitted when necessary.

The development also relates to a computer program product comprising program code instructions for implementing a method for requesting activation according to the development, as described previously, when it is executed by a processor.

The development also relates to a computer-readable storage medium on which the computer programs as described above are recorded.

Such a storage medium can be any entity or device able to store the program. For example, the medium can comprise a storage means, such as a ROM, for example a CD-ROM or a microelectronic circuit ROM, or a magnetic recording means, for example a USB drive or a hard drive.

On the other hand, such a storage medium can be a transmissible medium such as an electrical or optical signal, that can be forwarded via an electrical or optical cable, by radio or by other means, so that the computer program contained therein can be executed remotely. The program according to the development can be in particular downloaded on a network, for example the Internet network.

Alternatively, the storage medium can be an integrated circuit in which the program is embedded, the circuit being adapted to execute or to be used in the execution of the above-mentioned activation request method.

The development also relates to a device for requesting activation of at least one interface of an item of host equipment with a first local area communication network managed by said item of host equipment, said item of host equipment and said at least one interface being in standby mode.

Said device is configured to implement:
sending to the item of host equipment an application message requesting activation of said at least one interface of the first network on an interface that has remained active of the item of host equipment with a second local area communication network;
upon detection of the first network, sending a connection request to said interface; and
executing a service using said connection to the first network.

Advantageously, said device is configured to implement the above-mentioned processing method, according to its different embodiments.

Advantageously, said device is integrated into an item of terminal equipment configured to connect to the aforementioned item of host equipment.

Correlatively, the development finally relates to a system for managing a request for activating at least one interface with at least one second local area communication network of an item of host equipment by an item of terminal equipment, said host equipment being configured to manage a first local area communication network and to connect to a second local area communication network, said item of host equipment comprising at least one interface with the first network of said item of host equipment, said at least one interface being in standby mode, and at least one interface having remained active with the second local network.

The system comprises the aforementioned item of host equipment and the aforementioned item of terminal equipment.

### BRIEF DESCRIPTION OF THE DRAWINGS

Other purposes, features and advantages of the development will become more apparent upon reading the following description, hereby given to serve as an illustrative and non-restrictive example, in relation to the figures, among which:

FIG. 1 shows an example of architecture of a system for managing a request for activating an interface of an item of host equipment with a first local area communication network according to the development;

FIG. 2 diagrammatically illustrates an example of architecture of an item of host equipment incorporating a device for processing a request for activating an interface of the item of host equipment with the first local network according to one embodiment of the development, of an item of terminal equipment, integrating a device for requesting activation of said interface via an interface with a second local network according to one embodiment of the development;

FIG. 3 describes in the form of a flowchart the steps of a method for processing a request for activating an interface to the first local network managed by the item of host equipment, according to an embodiment of the development;

FIG. 4 describes in the form of a flowchart the steps of a method for requesting activation of an interface to the first local network by an item of terminal equipment, according to one embodiment of the development;

FIG. 5 describes in the form of a flow diagram the exchanges between the item of terminal equipment and the item of host equipment according to a first embodiment of the development;

FIG. 6: describes in the form of a flow diagram the exchanges between the item of terminal equipment and the item of host equipment according to a second embodiment of the development;

FIG. 7: describes an example of hardware structure of a device for processing a request for activating an interface of the item of host equipment with the first local area communication network according to the development; and

FIG. 8: describes an example of hardware structure of a device for processing a request for activation by an item of terminal equipment of an interface of the item of host equipment with the first local area communication network according to the development.

### DETAILED DESCRIPTION OF CERTAIN ILLUSTRATIVE EMBODIMENTS

The development relates to an item of host equipment configured to manage access to at least a first and a second local area communication network, in particular in a situation where this item of host equipment is in standby mode. The general principle of the development is based on the use, by an item of terminal equipment wishing to access the first local network, of an interface of the item of host equipment with the second local area communication network, this interface having remained active during the standby period of the item of host equipment, to transmit to the item of host equipment a request for activating an interface of this item of host equipment with a first local area communication network.

According to the development, upon receipt of this request, the item of host equipment verifies that the item of terminal equipment is authorised to access this first local network and, if necessary, wakes up the interface concerned. The item of terminal equipment can then detect the first network and request the establishment of a connection with this first network. Once connected, it can use this connection to run a programmed service. However, after its disconnection, the item of host equipment can put its interface back to standby mode with the first local network.

The development is particularly advantageous when the first communication network is a network whose associated data rate and therefore energy consumption level is higher than those of the second network. For example, the first local area communication network is based on Wi-Fi or Ethernet technology, whereas the second local area communication network is based on BLE technology. In this way, the fact of keeping an interface with the second local network active is not very costly in energy, but allows an item of terminal equipment already identified by the item of host equipment to execute a programmed service, such as for example a video surveillance service of the premises, while keeping the item of host equipment and its local networks in standby mode most of the time.

Naturally, the development is not limited to this embodiment and also applies to any other communication technology, wireless or wired, and for example to a second network based on a direct communication mode between communication equipment compatible with the 5G standard, i.e. without passing through the intermediary of a base station.

In the following, an interface with a communication network refers to hardware components enabling data to be sent/received by the intermediary of this network. For example, an interface with a Wi-Fi network is a Wi-Fi antenna configured to transmit/receive on a particular Wi-Fi frequency band, for example 2.4 GHz. Another interface with this Wi-Fi network is another antenna configured to transmit/receive on another particular Wi-Fi frequency band, for example 5 GHz. It is to be noted that these different interfaces can be managed by a same software application or by different applications.

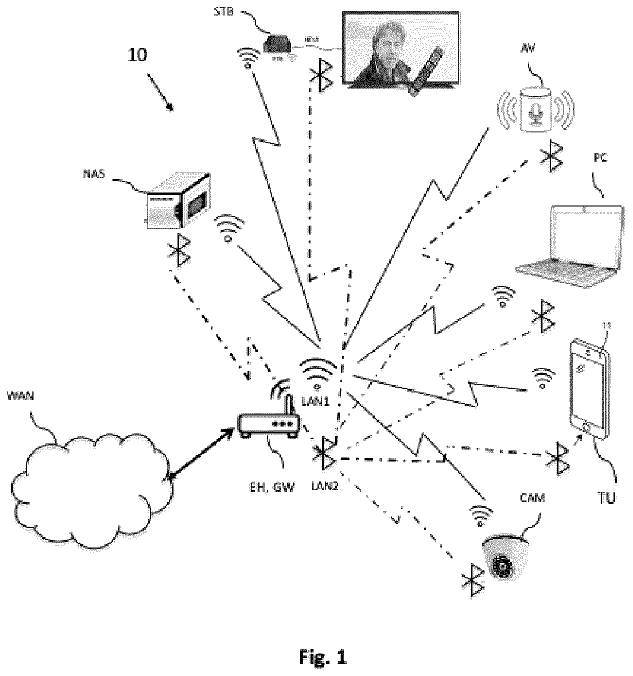

In relation to FIG. 1, an example of architecture of a system 10 for managing a request to activate an interface with a first local network according to an embodiment of the development is now presented. In this example, the first communication network LAN1 is managed by an item of host equipment EH via at least one wireless radio interface, for example of the Wi-Fi type. Naturally, the development is not limited to this example and applies to any other type of network, based for example on a wired link, such as Ethernet.

In this example, the item of host equipment EH comprises a gateway GW for access to a remote network WAN. In the example considered, the gateway is connected to the remote network WAN via an ADSL or fibre link. Of course, it can also connect to the operator's cellular network via a link of the 2G to 5G type.

In this example, the network LAN1 is a home network, to which several items of equipment are connected, such as a camera CAM, a voice assistant AV, a network storage server or NAS (“Network Attached Storage”), a decoder STB (“Set Top Box”), a personal computer PC and a mobile phone TU. These items of equipment connect to this first local network LAN1 of the item of host equipment EH by a Wi-Fi interface.

It is assumed that the item of host equipment EH manages a second local area communication network LAN2 via at least one interface, by another wireless radio link, for example with a lower speed than the Wi-Fi link of the first network LAN1, such as Bluetooth, Bluetooth Low Energy (BLE), z-wave, zigbee, DECT ULE etc., to which the items of terminal equipment mentioned above connect. In the following, it is assumed that this is a BLE interface.

For example, it is assumed that the user is away from home and has gone to a holiday resort for several days. It is also assumed that the administrator user of the gateway and of the home local network LAN, who may or may not be the user, has placed at least one part of the items of equipment of that network in a standby state. For example, he has activated the “Extended Absence” use scenario on a service administration portal of the item of host equipment EH proposed by his operator. For example, this portal is accessible from a mobile application installed on his phone TU or a web application accessible from a web browser of his laptop LTP. The explicit switch to this use scenario induces, for example:
sending commands to cut off the power supply to the connected electrical outlets that serve the items of equipment considered as non-essential, either explicitly predefined or by default,
sending standby commands (in ad hoc application messages) to the items of equipment likely to be woken up during this period, either on demand or by fixed or semi-random programming (presence simulation), such as STBs, TV sets, connected lamps,
saving in non-volatile memory on its gateway the network IDs, IP and MAC addresses of the items of equipment placed in a standby state,
sending commands to activate equipment dedicated to presence detection and alarms such as a central alarm station (not shown) and some stand-alone cameras,
stopping non-essential and energy-consuming interfaces on the gateway, such as Wi-Fi or 4G/5G where applicable, and maintaining others, such as BLE and Ethernet,
stopping non-essential and energy-consuming applications on the item of host equipment,
activating a program on the item of host equipment that manages a presence simulation calendar with communication of its programming to the central
alarm station, so that its light or suspicious noises detection system is not disturbed,
activating a program on the item of host equipment that manages a standby and wake-up calendar of some interfaces of the item of host equipment, such as its Wi-Fi interface.

Switching some items of equipment to standby or monitoring mode (for example, the stand-alone camera) induces in these:
maintaining in working order Bluetooth Low Energy (BLE) interfaces on equipment equipped with them, such as the camera CAM and the item of host equipment itself,
placing in a standby state or stopping the Wi-Fi interfaces of the items of equipment that also have a Bluetooth Low Energy (BLE) interface,
stopping some of their components and embedded applications,
monitoring by them of wake-up messages on their BLE and Ethernet interfaces.

By way of example, the following use case is considered:
during a prolonged absence of the inhabitants of the home, the camera CAM is configured to emerge from standby mode regularly to capture a still image or short video of the interior of the home and transmit it to a remote storage server, for example in the cloud. To do this, it needs access to the first local network LAN1, and then via the item of host equipment to the remote network WAN.

Naturally, the development is not limited to this example and applies to any other service offered by an item of terminal equipment and which requires connecting to the first local network LAN1 in order to be executed.

As illustrated by FIG. 1, the system 10 according to the development comprises the item of host equipment EH configured to manage the first local network LAN1, the second local network LAN2 and optionally to route data to the remote network WAN. The system 10 also comprises at least one item of terminal equipment, such as the camera CAM, configured to provide a service that uses the first local network LAN1 and optionally the remote network WAN.

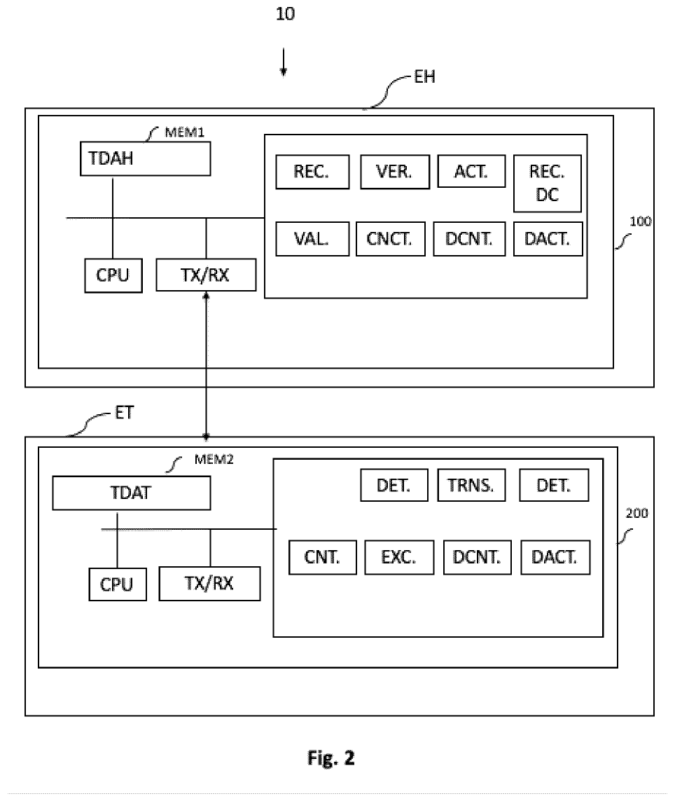

FIG. 2 shows a first example of architecture of the item of host equipment EH according to an embodiment of the development. According to this first example, the item of host equipment EH comprises a device 100 for processing a request to activate an interface of the first network LAN1 according to the development. This device is configured to receive, from an item of terminal equipment ET, for example the camera CAM, an application message requesting activation of said interface of the first network LAN1 on an interface that has remained active of the second local area communication network LAN2 managed by said item of host equipment, verifying that the item of terminal equipment is authorised to access said at least one first network LAN1 from an address of the item of terminal equipment for the second network, for example by consulting a table storing access rights of the item of terminal equipment to the interface of the first local network LAN1 and, when the item of terminal equipment is authorised to access said at least one first network, activating said interface with the first network LAN1.

Alternatively, the device 100 may be independent of the host equipment EH, but connected to it by any link, wired or not.

In particular, the processing device 100 comprises at least one module REC. for receiving the activation request of the interface of the first local network LAN1, a module VER. for verifying access rights of the item of terminal equipment ET and a module ACT. for activating said interface.

Advantageously, the device 100 comprises at least one module REC. for receiving a request for connection to the first network LAN1, a module VAL. for validating the request and a connection of the item of terminal equipment to the first network LAN. It also includes a disconnection module DCNT. and a deactivation module DACT. of the interface of the item of host equipment EH with the first network LAN1. It finally comprises a module TX/RX for receiving and transmitting information via said interface with the first network LAN1 and said interface with the second network LAN2. Alternatively, it uses the transmission/reception module of the item of host equipment EH into which it is integrated.

The non-volatile memory MEM1 advantageously comprises a table TDAH associating with an identifier of the item of terminal equipment access rights to the first local network and to the second local network.

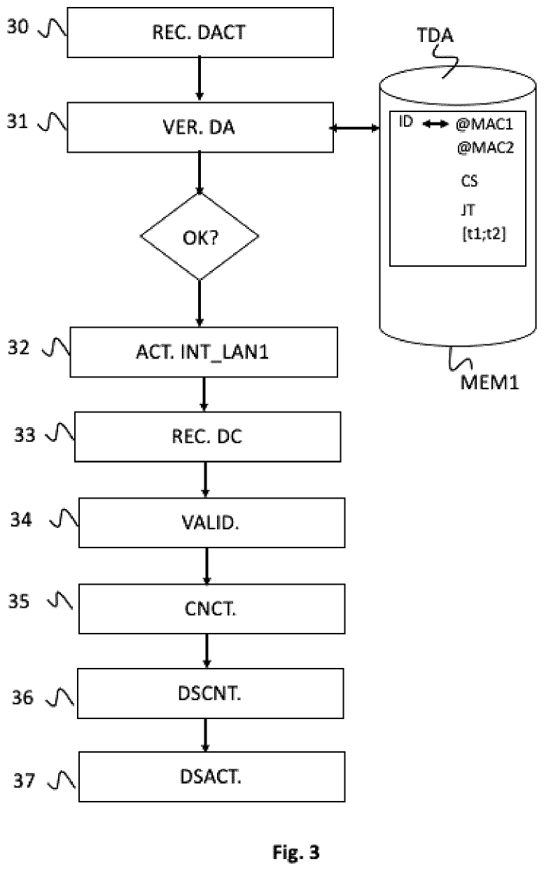

The device 100 thus implements the method for processing a request for activating an interface of the first local network LAN1 according to the development that will be detailed hereafter in relation to FIG. 3.

Finally, FIG. 2 shows an example of architecture of an item of terminal equipment ET according to an embodiment of the development. According to this example, the item of terminal equipment ET comprises a device 200 for requesting activation of an interface of the first local network LAN, configured to send to the item of host equipment an application message for waking up said interface of the first network on an interface that has remained active of a second local area communication network of said item of host equipment, upon detection of the first network, send a connection request to said interface of said first network; and execute a service using said connection to the first network. Alternatively, the device 200 may be independent of the item of terminal equipment ET, but connected to it by any link, wired or not.

In particular, the activation request device 200 comprises a module TRNS. for sending a wake-up application message from the interface of the item of host equipment with the first network to the interface of the item of host equipment with the second network, a module DET. for detecting the first network, a module REQ. CNT for connecting to the first network and a module EXC. for executing the service using the connection established with the first network.

Advantageously, the device 200 also comprises a module DCNT. for disconnecting the item of terminal equipment ET from the first network LAN1 and a module DACT. for deactivating the interface of the item of terminal equipment with this first network. It finally comprises a module TX/RX for receiving and transmitting information via the interface with the first local network LAN1 and the interface with the second local network LAN2. Alternatively, it uses the emission/reception module of the item of terminal equipment ET into which it is integrated.

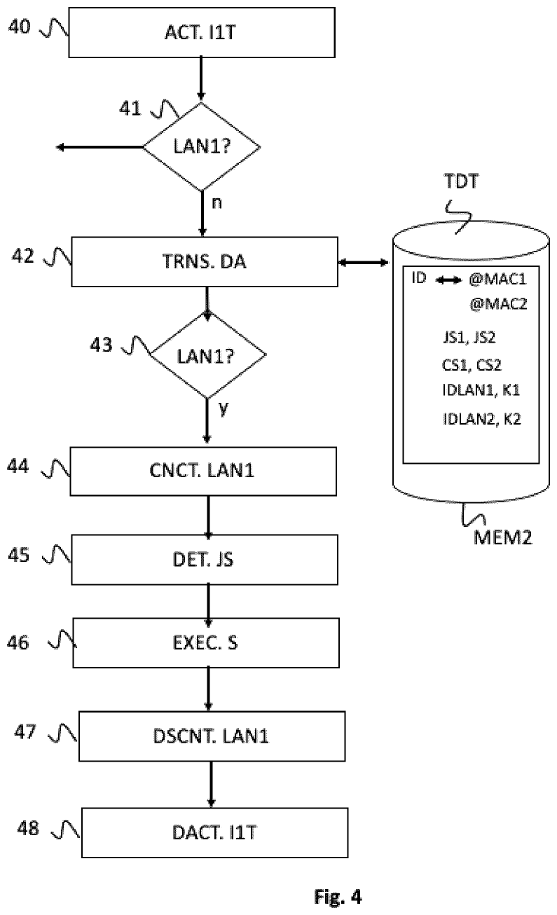

The device 200 thus implements the method for requesting activation of an interface of the first local network LAN according to the development that will be detailed hereafter in relation to FIG. 4.

In relation to FIG. 3, according to one embodiment of the development, an embodiment of the method for processing at least one interface of an item of host equipment with at least one first local area communication network managed by said item of host equipment, said item of host equipment and said at least one interface being in standby mode is now presented in the form of a flowchart.

In the following, it is assumed that the item of host equipment EH has an interface I2H that has remained active with the second network LAN2 and that its interface(s) I1H with the first network LAN1 are inactive.

In the following, equipment address refers to the address used in data packets at data link level, regardless of the type of link and/or communication protocol used. For example, for many types of link, including Wi-Fi links, this is a MAC address, whereas in BlueTooth and BLE in particular, this address is referred to as “BD-ADDRESS”.

During a step 30, the item of host equipment EH, in standby mode, receives an application message DACT requesting activation of its interface I1H with the first local area network LAN1 from the item of terminal equipment ET, on an interface I2H with the second local area network LAN2, that has remained active. For example, the interface I1H with the first local network LAN1 is based on a Wi-Fi technology and the interface I2H with the second local network LAN2 is based on BLE technology.

The request DACT is an application message whose purpose may be implicit or explicit. In other words, in the implicit case, the simple fact of receiving this message from the item of terminal equipment ET on the second local network may be enough to trigger the waking up of an interface of the item of host equipment with the first local network according to the development. This is a simple embodiment of the development, according to which the application message is reduced to a data packet with no payload and from which the item of host equipment EH verifies, for example, that the link-level address of the terminal on the second network LAN 2 (MAC address for example) which generated it does indeed belong to a set of authorised addresses that it has in memory. However, the level of security is low.

In the explicit case, the application message includes at least one item of information E1-LAN directly or indirectly indicating the local network to be activated. This may be, for example, a sequence of characters interpreted by the item of host equipment as the action of waking up an interface of the first local network LAN1, or the address @MAC1H of the interface between the item of host equipment and the local network LAN1 to be activated.

This item of information may also comprise an identifier or label of the service that the item of terminal equipment ET wishes to execute. In the latter case, the item of host equipment EH obtains a description of the service in question, for example by consulting a services orchestrator implemented by the item of host equipment EH from the label received and in this way is informed that this service needs to use the first network LAN1 to transfer data to the item of host equipment EH. In this way, the application APPH can also obtain an item of information that the service needs to transmit this data to an item of remote server equipment, accessible via a remote network WAN. In other words, in order for the service to be executed, it is proper to activate the access gateway GW of the item of host equipment EH with the network WAN.

The interface I2H retrieves the address @MAC2T of the item of terminal equipment ET in the envelope of the application message DACT received, then wakes up an application APPH of the item of host equipment configured to manage the interfaces of this host equipment with the various local networks LAN1, LAN2. To do this, it transmits to it a wake-up application message WAK, for example.

According to another embodiment of the development, a unique network identifier IRU is considered of the item of terminal equipment ET which is used by the interfaces of the different interfaces with the different local networks managed by the item of host equipment EH. This unique network identifier has a specific physical or link address format. It is currently being studied by standards bodies such as the IEEE. In this case, the unique network identifier IRU replaces the @MAC1T, @MAC2T addresses of the item of terminal equipment ET. For example, the item of information EIH-LAN comprises at least the unique network identifier of the item of host equipment IRUH.

In the following, the embodiment according to which the item of terminal equipment and the item of host equipment have an address of MAC type for each interface with a particular local network is described.

In 31, the management application verifies that the item of terminal equipment ET is authorised to activate the local area network LAN1. This verification is based on the consultation of an access rights table TDA, for example stored in local memory of the device 100 or of the item of host equipment EH. It is about verifying that the address @MAC2T of the item of terminal equipment ET in the second local network LAN2 is well associated with at least one address @MAC1T of the item of terminal equipment ET in the first local network LAN1.

Optionally, the table TDAH also associates one or more authorised time slots for requesting access to the second local network LAN2. Thus, in 31, it is also verified that the activation request of the network LAN1 was received in one of these authorised time slots. For example, office hours, from 8 a.m. to 6 p.m., are authorised, while other hours are prohibited, in order to protect the installation of a small business that wishes to limit the risks of hacking during the night.

In one embodiment, the activation request DACT also includes a temporary session token. Such a temporary token is advantageously associated with a previous connection session of the item of terminal equipment to the first local network LAN1 and changed with each new connection. Associating it with the activation request enables the item of host equipment EH to verify that this temporary token is indeed associated in the table TDA with the identifier of the item of terminal equipment and with its link address @MAC1T in the first network LAN1 and thus to forbid any re-use, that is the repeated sending of the same activation request by an item of pirate terminal equipment which would have usurped the link address @MAC2T of the item of terminal equipment ET.

For example, the temporary token, common to the item of terminal equipment ET and the item of host equipment EH, is generated by each of them separately, using a same algorithm. Advantageously, this algorithm produces a series of tokens.

Several tokens created in succession can be considered valid at a given time, which allows to take into account the fact that the item of host equipment does not receive all the messages sent by the item of terminal equipment on the second local network LAN2. In this case, the successful reception of a particular token by them causes the item of host equipment to delete the previous tokens that are still unused. It is noted in this regard that the tokens are for single-use. If the item of terminal equipment uses a particular token, it considers that the tokens it generated before that one are out of date.

For example, to initialise the sequence of tokens, a first token value is entered by a user on both the item of host equipment and the item of terminal equipment ET at the time of the initial configuration. Alternatively, an ad hoc application exchange is implemented between the item of host equipment and the item of terminal equipment to initialise this sequence of tokens.

When the result of the verification is positive, the application APPH of the item of host equipment EH activates in 32 the interface I1H of the item of host equipment EH with the first network LAN1.

Optionally, the application APPH triggers an activity counter CA for the interface I1H with the first local network LAN1.

Optionally, the item of host equipment retrieves in 33 a previous session context from the item of terminal equipment in the first local network LAN1. Advantageously, this session context is associated with the session token received. For example, this context is managed at the application level and stored in the table TDA in association with the address @MAC2T of the item of terminal equipment ET in the second local network LAN2 or it is managed at the network interface level in another table TCS where it is indexed by the session token.

Such a session context includes in particular the encryption keys of the previous communication session involving the item of terminal equipment ET on the second local network LAN2 of the item of host equipment EH. For example, for a network based on Wi-Fi technology, these are keys specific to the previous Wi-Fi session.

One advantage of saving such a context is that it makes it possible to reconnect the item of terminal equipment ET quickly to the network LAN2, i.e. to dispense with certain connection steps such as exchanging the transmitter and receiver encryption keys, the network identifier and the password (or network key). However, for obvious security reasons, such re-use of a previous context is only permitted for a specific period of time. As a result, the management application APPH of the item of host equipment EH maintains a fast reconnection counter TRC which it initialises when a new ab initio session is established. When this counter reaches a predetermined maximum value, for example equal to 10 connections or to 1 hour, a fast reconnection based on this context is no longer authorised. The management application APPH thus verifies in 34 whether the fast reconnection counter TRC is below the maximum value and decides accordingly whether or not to implement a fast reconnection.

In 33, the item of host equipment receives a connection request DCN on its interface I1H from the item of terminal equipment ET.

In 34, it retrieves the address @MAC1T of the item of terminal equipment ET from the envelope of the connection request received and validates that it matches the one associated with the address @MAC2T of the item of terminal equipment for the second network LAN2 in the table TDA.

The connection is then established in 35 in a way that is known per se.

Once the connection has been established, the item of host equipment EH involves in 35 a connection management application exchange with the item of terminal equipment, during which one or more new session tokens JS are generated. A first token JS will be usable for the next communication session of the item of terminal equipment ET with this first local network LAN1 via this interface I1H. The management application APPH saves it in the table TDA. If necessary, it records a new association between this new session token JS and the session context in the connection management table TC.

In 36, the application APPH disconnects the item of terminal equipment. This may be at its request or when the activity counter CA has reached a predetermined maximum value, called end value, for example equal to 10 minutes. Managing such an activity counter makes it possible to control the wake-up times of the local network interfaces and therefore the energy consumption of the item of host equipment EH when it has been placed in extended standby mode. It is a means of protecting against a malfunctioning of a terminal which, if not disconnected, would affect the energy consumption and security of the local network LAN1. Advantageously, the predetermined maximum value could be chosen specifically for each terminal registered to the network LAN1.

The maximum value of such a counter could be different for each registered terminal.

In 37, the item of host equipment deactivates its interface with the first local network LAN1, then the interface management application.

In relation to FIG. 4, an example of implementation of a method for requesting activation by an item of terminal equipment of an interface 11H of an item of host equipment EH with a first local network LAN1 that it manages, according to an embodiment of the development is now presented in the form of a flowchart. In particular, it is assumed that the item of terminal equipment ET is equipped with an application APPT configured to run a service S that needs to establish high-speed communication with the item of host equipment EH, for example to transfer image or video data to it. To do this, the application APPT seeks to connect to a high-speed local network of the item of host equipment EH, such as the first network LAN1.

In particular, it is assumed that the interface I2T of the item of terminal equipment ET with the second network LAN2 has remained active. As a reminder, the network LAN2 is a low-speed network, for example based on BLE technology.

In 40, the application APPT activates the interface I1T of the item of terminal equipment ET with the first local area communication network LAN1 of the item of host equipment EH, which listens to the network LAN1. If the first network LAN1 is detected in 41, then the application APPT sends a connection request DCN to the detected interface I1H of the item of host equipment EH with this network and the process stops.

Otherwise, the application APPT sends in 42 an activation request DACT for the interface I1H of the item of host equipment EH with the first network LAN1 via this second local network, whose interface I2H has remained active.

The request DACT is an application message. Advantageously, it includes an item of information E1-LAN indicating the local network to activate. This can be a sequence of characters, for example, or the address @MAC1H of the interface of the item of host equipment to activate with the local network LAN1.

It is assumed that the application APPT accesses a table TDT, for example organised as a persistent database, maintained by the item of terminal equipment ET, comprising for each of the interfaces with host equipment local area communication networks to which it or more generally the item of terminal equipment is authorised to connect, a local network identifier, a local network password or key, the @MAC1T, @MAC2T address of the item of terminal equipment for the interface considered, optionally the currently valid session token(s) JS and the session context CS to be recalled to obtain a fast reconnection.

According to another example, already mentioned in relation to FIG. 3, this data element comprises an identifier, also called a label, of a service implemented by the item of terminal equipment ET, said service using the first network LAN1 and for which the item of host equipment is itself able to make a suitable complementary contribution. For example, this contribution consists in waking up its Wi-Fi interface to enable the item of terminal equipment to obtain a file from a remote server and in verifying the IP address of this remote server. In the latter case, the interface management application of the item of host equipment EH obtains a description of the service in question, for example by consulting a service orchestrator implemented by the item of host equipment EH from the label received and in this way is informed that this service needs to use the first network LAN1 to transfer data to the item of host equipment EH.

Optionally, the request DACT also includes a session token JS used during a previous connection to the first network LAN1. As previously described in relation to FIG. 3, the fact of indicating this session token enables the interface management application of the item of host equipment EH to verify that this activation request is legitimate and is not reused by an item of terminal equipment that has usurped the address @MAC2T of the item of terminal equipment ET.

In 43, following the transmission of this activation request, the application APPT relaunch a search for available local area communication networks. It is assumed that the interface I1H of the first local network LAN1 has been activated following processing of the activation request DACT transmitted by the item of terminal equipment ET to the interface 12H of the item of host equipment and that it is detected by the interface I1T of the item of terminal equipment ET.

In 44 it therefore transmits a DC connection request from its Wi-Fi interface to the first network LAN1. This connection request DC includes in its envelope the address @MAC1T of the item of terminal equipment ET and the address @MAC1H of the item of host equipment EH for this first network LAN1. Optionally, the message body includes the session token JS.

According to one embodiment of the development, it is assumed that following the activation of the interface I1T with the network LAN1, the application APPT has verified that a reconnection counter CRT had not expired, i.e. reached a predetermined maximum value. If the counter CRT is still valid, then the connection request DC includes a context of a previous connection, with a view to a fast reconnection.

As previously mentioned, the connection request DC is processed by the management application APPH of the item of host equipment in a manner known per se.

Optionally, a fast reconnection is implemented if the management application APPH validates on its side that it is authorised. In this respect, it should be noted that the reconnection counter CRH of the item of host equipment can expire at a predetermined maximum value different from the one configured on the item of terminal equipment side. Indeed, it is often more convenient to change the default configurations at the item of host equipment than at the item of terminal equipment ET. It is therefore quite conceivable that the user could modify, and for example lower, this threshold value at the host equipment to make his network installation more secure.

Once the connection has been established in 45 between the interfaces I1T and I1H of the network LAN1, at least one new session token is negotiated for the next session and the tables TDAT and TDAH are updated accordingly on the item of terminal equipment ET and item of host equipment EH sides.

The application APPT of the item of terminal equipment ET executes at least one service in 46 using said connection to the first local network LAN1.

When it has finished executing this service, it requests in 47 to disconnect from the first network LAN1 and then disables in 48 the interface I1T of the item of terminal equipment ET.

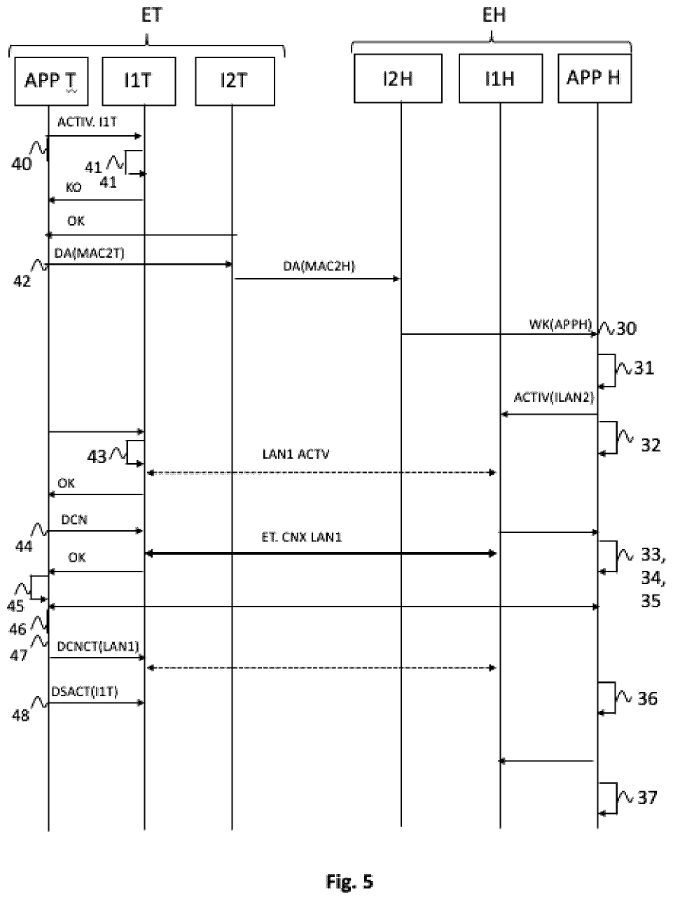

In relation to FIG. 5, the exchanges of messages between the item of terminal equipment ET and the item of host equipment EH according to a first embodiment of the development are now presented in the form of a flow diagram. In this figure, the application APPT of the item of terminal equipment ET which needs to access a first high-speed local network LAN1 managed by the item of host equipment EH, an interface I1T of the item of terminal equipment with the first network LAN1 and an interface I2T of the item of terminal equipment ET with a second low-speed local network LAN2 are shown on the left. On the right are shown, for the item of host equipment EH, an interface I1H with the first local network LAN1 that it manages, an interface I2H with the second local network LAN2 that it manages and a management application AG of these interfaces.

For example, the item of terminal equipment ET is a connected camera CAM and this application APPT implements a home surveillance service S by regularly capturing photos or videos and transmitting the captured files to a remote server equipment accessible via a remote network WAN. This application APPT remains active during the extended standby of the item of host equipment EH, its local networks and the connected objects and other terminal equipment in the home. For example, the interface I1T with the first network LAN1 is of Wi-Fi type and the interface I2T is of BLE type.

When an activity counter is triggered or, for example, at a given time determined by a calendar, the application APPT of the item of terminal equipment ET activates the interface I1T of the item of terminal equipment ET in 40. In 41, it starts listening if the first local network LAN1 is available. It is assumed that the interface I1T detects no signal.

In 42, the application APPT sends an activation request from the interface I2T of the item of terminal equipment ET to the interface I2H of the EG host equipment. On receiving this message, the interface I2H recovers the link address @MAC2T of the item of terminal equipment for the second local network LAN and transmits a wake-up application message WAK to the interface management application APPH, said message comprising at least the recovered link address @MAC2T.

Once awake, the application APPH verifies in 31 the access rights of the item of terminal equipment ET to the first network LAN1, from the identifier and the address @MAC2T retrieved, by consulting the table TDA previously described in relation to FIGS. 2 and 3.

When it has established that the item of terminal equipment ET is authorised to access the first network LAN1, the application APPH sends a wake-up message to the interface I1H of the item of host equipment EH in 32. The interface I1T, which has been listening to the first local network LAN1, detects this in 43 and informs the application APPT. In response, the latter sends a connection request DC to the first network LAN in 44 to the interface I1T, which forwards it to the corresponding interface 11H of the item of host equipment EH. The two interfaces establish a connection. Once this connection has been established, the application APPT uses this connection to transmit the image or video file in 45 to the item of host equipment EH.

Advantageously, the application APPT indicated an identifier for the service in question in its activation request DACT. Using this identifier, the management application APPH obtained information about the service, for example from an orchestrator implemented by the item of host equipment EH. In particular, it obtained information to the effect that the service required access to the network WAN by the intermediary of the gateway integrated into the item of host equipment. The application APPH therefore transmitted a wake-up message to the interface WAN of the item of host equipment EH. Hence, the item of host equipment can then transmit the image or video file received to the remote server for the application APPT. In this case, the item of host equipment receives a first transfer of the file in question from the item of terminal equipment, and then sends a second transfer of the file to the remote server. Alternatively, the application APPT connects to the interface WAN of the item of host equipment and transmits its file directly to the remote server. In this second case, the item of host equipment is transparent for the file transfer between the item of terminal equipment and the remote server, once it has connected them.

Once the service is executed, the application APPT requests to be disconnected from the first network LAN1. On receiving this request, the interface 11H terminates the connection.

Once the disconnection is carried out, the application APPT disables the interface I1T of the item of terminal equipment ET with the first network LAN1.

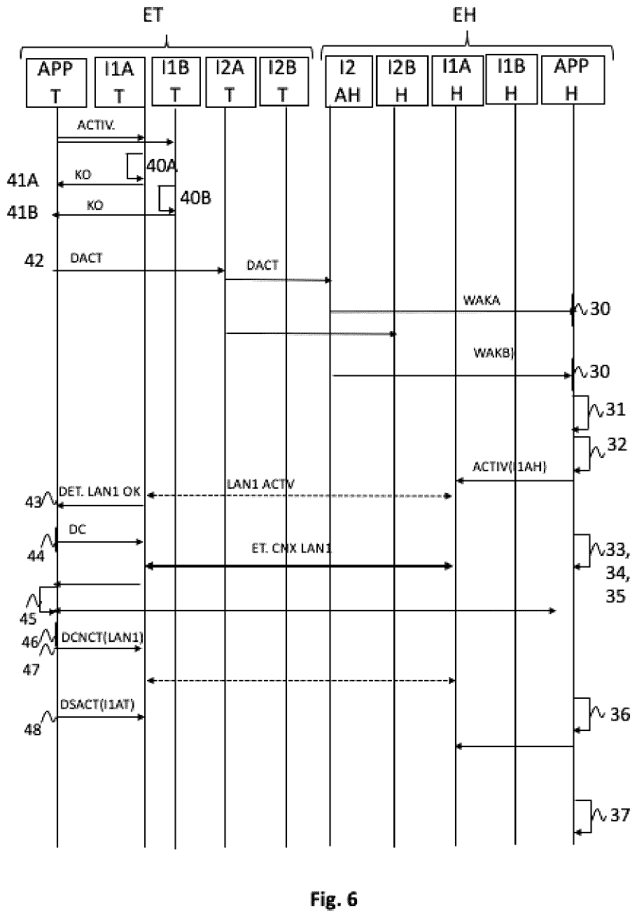

In relation to FIG. 6, the exchanges of messages between the item of terminal equipment ET and the item of host equipment EH according to a second embodiment of the development are now presented in the form of a flow diagram.

In this second example, it is assumed that the item of host equipment EH has several interfaces with each of the two networks LAN1, LAN2 that it manages. For example, the item of host equipment EH comprises a terminal A and a terminal B, each equipped with a data emission/reception module on the first network LAN1 corresponding to an interface 11AH, 11BH and a data emission/reception module on the second network LAN2 corresponding to a second interface I2AH, I2BH. For example, for the first network LAN1, the modules in each terminal address different Wi-Fi frequency bands. Similarly, it is assumed that the item of terminal equipment also has two separate interfaces 11AT, 11BT, I2AT, I2BT with each of the local area networks LAN1, LAN2 managed by the item of host equipment EH.

In this embodiment, the item of terminal equipment ET and the item of host equipment EH use a separate address on each of the aforementioned interfaces. Naturally, the development also applies in the case where these addresses are replaced by a unique network identifier IRU, as mentioned above.

The application APPT of the item of terminal equipment ET activates interfaces 11AT and 11BT with the first local network LAN1 in 40A, 40B, which start listening to the network. As no signal is detected in 41A, 41B, the application commands in 42 the transmission of a request to activate the first local network LAN1 on the second local network LAN2 whose interfaces I2AH, 12BH with the item of host equipment EH have remained active.

These two interfaces both receive the activation request DACT application message sent by the item of terminal equipment ET and each retrieve the corresponding link address @MAC2AT. @MAC2BT from the item of terminal equipment ET.

Each transmits a wake-up application message WAKA, WAKB to the interface management application APPH, said wake-up message comprising at least the retrieved link address @MAC2AT, @MAC2BT of the item of terminal equipment ET and an item of information IMP representative of a received power measurement IP2A, IP2B on the interface concerned. On receipt, in 31, the management application APPH verifies that the item of terminal equipment ET is authorised to activate the first network LAN1 as previously described in relation to FIGS. 3-5. If required, it compares the power information 2B received and selects from the two interfaces 11AH and 11BH the one which belongs to the same terminal as the interface I2AH, 12BH associated with the highest power measurement information. Since the emission/reception modules of a same terminal are co-located, it can be assumed that if it has received more powerful signals on one interface of this terminal, the same will be true for another co-located interface. In what follows, this is considered to be the interface 11AH.

The management application APPH sends a wake-up message to this interface 11AH of the item of host equipment EH with the first network LAN1.

The interface 11AT of the item of terminal equipment ET which has been listening to the first local network LAN1 detects a signal and informs the application APPT in 43. In response, it sends a DC connection request to the first network LAN1 to the interface I1T, which forwards it to the corresponding interface 11AH of the item of host equipment EH. The following exchanges are of the same nature as those already described in relation to FIG. 5.

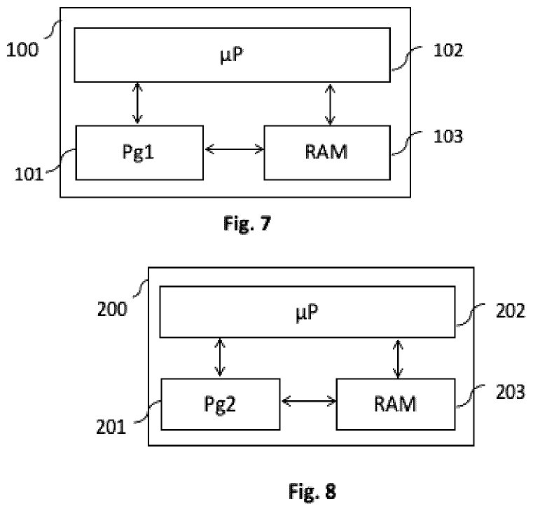

An example of hardware structure of a device 100 for processing a request for activating an interface of a first local area communication network according to the development is now presented in relation to FIG. 7, comprising, as illustrated by the examples in FIGS. 2, 5 and 6, at least one module for receiving from an item of terminal equipment an application message requesting activation of said interface of the first network on an interface that has remained active of a second local area communication network managed by said item of host equipment, a module for verifying that the item of terminal equipment is authorised to access the first network, from a physical address of the item of terminal equipment for the second local network, and a module for activating the at least one interface of the first local network of the item of host equipment, when the item of terminal equipment is authorised to access said at least one second network.

Advantageously, the device 100 further comprises a module for receiving a connection request to the first local network from the item of terminal equipment, a module for verifying that the physical address of the item of terminal equipment received in the connection request corresponds to the one associated with the physical address of the item of terminal equipment for the second local network, a module for disconnecting the item of terminal equipment and a module for deactivating the interface of the item of host equipment with the first local network.

The term “module” can correspond to a software component as well as to a hardware component or a set of hardware and software components, a software component itself corresponding to one or more computer programs or sub-programs, or more generally, to any element of a program capable of implementing a function or set of functions.

More generally, such a device 100 comprises a random access memory 103 (a RAM memory, for example), a processing unit 102 equipped for example with a processor and controlled by a computer program Pg. representative of the aforementioned modules, stored in a read-only memory 101 (a ROM memory or hard disk, for example). At initialisation, the code instructions of the computer program are for example loaded into the random access memory 103 before being executed by the processor of the processing unit 102. The random access memory 103 can also contain a table TDAH comprising an entry associating access rights with an identifier of the item of terminal equipment ET, such as a physical address on the second local network or a unique network identifier IRU. It can also contain time slots during which the activation of the first local network is authorised/forbidden. It may also comprise a valid session token for connecting the item of terminal equipment to the first local network as well as a communication session context.

FIG. 7 only shows a particular one of several possible ways of realising the device 100, so that it executes the steps of the method for processing a request for activating an interface of the item of host equipment with a first local network as detailed above, in relation to FIGS. 3, 5 and 6 in its different embodiments. Indeed, these steps may be implemented indifferently on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the device 100 is realised with a reprogrammable computing machine, the corresponding program (that is the sequence of instructions) can be stored in a removable (such as, for example, an SD card, a USB drive, a CD-ROM or a DVD-ROM) or non-removable storage medium, this storage medium being partially or totally readable by a computer or a processor.

The various embodiments have been described above in relation to a device 100 integrated into an item of host equipment ET, comprising for example a gateway to access a remote communication network WAN and configured to manage the first and second local communication networks LAN1, LAN2, but it may also be independent of the item of host equipment EH and connected to it via an interface.

Finally, in relation to FIG. 8, an example of the hardware structure of a device 200 for requesting activation of an interface of an item of host equipment with a first local network that it manages according to the development is presented, comprising, as illustrated by the examples of FIGS. 4-6, at least one module for sending to the item of host equipment an application message requesting activation of the said at least one interface of the first network on an interface that has remained active of a second local area communication network of the said item of host equipment, a module for detecting the first local network, a module for sending a connection request on said interface of the first local network and a module for executing a service using said connection to the first network.

Advantageously, the device 200 also comprises a module for detecting the first network.

The term “module” can correspond to a software component as well as to a hardware component or a set of hardware and software components, a software component itself corresponding to one or more computer programs or sub-programs, or more generally, to any element of a program capable of implementing a function or set of functions.

More generally, such a device 200 comprises a random access memory 203 (a RAM memory, for example), a processing unit 202 equipped for example with a processor and controlled by a computer program Pg2, representative of the aforementioned modules, stored in a read-only memory 201 (a ROM memory or hard disk, for example). At initialisation, the code instructions of the computer program are for example loaded into a random access memory 203 before being executed by the processor of the processing unit 202. The random access memory 203 can also contain a table TDAT comprising an entry associating an identifier of the item of terminal equipment ET, such as its physical address for the second local network or a unique network identifier IRU, with connection information to the first local network managed by the item of host equipment EH.

FIG. 8 only shows a particular one of several possible ways of realising the device 200, so that it executes the steps of the activation request method as detailed above, in relation to FIGS. 4 to 6 in its various embodiments. Indeed, these steps may be implemented indifferently on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the device 200 is realised with a reprogrammable computing machine, the corresponding program (that is the sequence of instructions) can be stored in a removable (such as, for example, an SD card, a USB drive, a CD-ROM or a DVD-ROM) or non-removable storage medium, this storage medium being partially or totally readable by a computer or a processor.

The development that has just been described in its different embodiments has many advantages. In particular, it enables an item of terminal equipment authorised to connect to an item of host equipment of a network installation in extended standby mode, to wake up a local network quickly and securely which it needs to transfer data. With the development, this wake-up is advantageously managed at the application level by using hardware components that are already available, such as for example an interface with another low-speed, low-energy consumption local area network.

1. A method of processing a request to activate at least one interface of an item of host equipment with a first local area communication network managed by the item of host equipment, the item of host equipment and the at least one interface being in standby mode, wherein the method comprises:
receiving from an item of terminal equipment of an application message requesting activation of the interface of the item of host equipment with the first network on an interface, that has remained active, of the item of host equipment with a second local area communication network;
verifying that the item of terminal equipment is authorized to access the at least one first network from an address, referred to as a second address, of the item of terminal equipment on the second network, and
when the item of terminal equipment is authorized to access the at least one first network, activating the at least one interface of the first network.

2. The method of processing according to claim 1, wherein the verifying comprises consulting a table stored in memory, the item of terminal equipment being authorized to access the first local network, when the table associates at least with the second address of the item of terminal equipment for the second local network an address, referred to as a first address, of the item of terminal equipment for the first local network.

3. The method of processing according to claim 2, wherein the verifying includes verifying that the activation request has been received within an authorized time slot.

4. The method of processing according to claim 1, wherein the receiving comprises obtaining an item of information indicating that the action requested is the activation of the first local network, the item of information being included in the message.

5. The method of processing according to claim 1, wherein the receiving comprises obtaining at least one item of information identifying a service performed by the item of terminal equipment, the item of information being included in the message, and in that the verifying comprises verifying that the service is authorized.

6. The method of processing according to claim 5, wherein the item of host equipment comprises an interface with a wide area communication network, the method comprises determining from the service identifier other network interfaces to activate for implementing the service and activating the other network interfaces.

7. The method of processing according to claim 2, wherein, following activation of the at least one interface with the first network, on reception of a connection request to the first network from the item of terminal equipment on the interface, the connection request comprising at least the first address of the item of terminal equipment for the first network and information for connecting the item of terminal equipment to the first network, the method comprises:
verifying that the first address received from the item of terminal equipment in the first network is associated in the table with the second address of the item of terminal equipment in the second network, and
when the verification is positive, connecting the item of terminal equipment to the first network using the connection information.

8. The method of processing according to claim 7, wherein the activation request message comprising a session token of the item of terminal equipment on the first network, the verification comprises a comparison of the received session token with a session token stored in the table in association with the identifier of the item of terminal equipment and a validation of the received token when it is identical to the stored session token.

9. The method of processing according to claim 8, wherein the method comprises obtaining information relating to a context of a previous communication session on the first network from the session token and verifying that a time counter associated with the context has not expired and, in that when the time counter has not expired, connecting to the first network comprises recovering the session context from the information obtained.

10. The method of processing according to claim 1, wherein the activation request having been received on a first and a second interface with the second network, the method comprises determining a power measurement of a signal received on the first and second interfaces and selecting an interface to activate for the first network from a first and a second available interfaces, the selected interface being associated with the one with the second network corresponding to the highest power measurement.

11. A method of requesting to activate at least one interface of an item of host equipment with a first local area communication network managed by the item of host equipment, the item of host equipment and the at least one interface being in standby mode, wherein the method is implemented by an item of terminal equipment and comprises:
sending to the item of host equipment an application message requesting activation of the at least one interface of the first network on an interface that has remained active of the item of host equipment with a second local area communication network;
upon detection of the first network, sending a connection request to the interface; and
executing a service using the connection to the first network.

12. The method of requesting to activate according claim 11, wherein the method comprises a search for the first network of the item of host equipment and in that it triggers the transmission in the second network of an application message requesting activation of an interface of the item of host equipment with the first network in the absence of detection of the first network.

13. A processing circuit comprising a processor and a memory, the memory storing program code instructions of a computer program for implementing the method according to claim 1, when the computer program is executed by the processor.

14. A device for processing a request to activate at least one interface of an item of host equipment with a first local area communication network managed by the item of host equipment, the item of host equipment and the at least one interface being in standby mode, wherein the device is configured to:
receive from an item of terminal equipment of an application message requesting activation of the interface of the first network on an interface, that has remained active, of the item of host equipment with a second local area communication network;
verify that the item of terminal equipment is authorized to access the at least one first network from an address, referred to as a second address, of the item of terminal equipment on the second network, and
when the item of terminal equipment is authorized to access the at least one first network, activate the at least one interface of the first network.

15. A device for requesting to activate at least one interface of an item of host equipment with a first local area communication network managed by the item of host equipment, the item of host equipment and the at least one interface being in standby mode, wherein the device is configured to:
send to the item of host equipment an application message requesting activation of the at least one interface of the first network on an interface that has remained active of the item of host equipment with a second local area communication network;
upon detection of the first network, send a connection request to the interface; and
execute a service using the connection to the first network.

16. A host equipment (EH) configured to manage a first local area communication network and a second local area communication network, the item of host equipment comprising at least one interface with the first network, the host equipment and the at least one interface being in standby mode, and at least one interface that has remained active with the second local network, wherein the item of host equipment comprises a device for processing a request for activating an interface with the first network from an item of terminal equipment according to claim 14.

17. A terminal equipment configured to connect to an item of host equipment configured to manage at least one first local area communication network and at least one second local area communication network, the item of host equipment being in standby mode, wherein the terminal equipment comprises a device for requesting activation of at least one interface of the item of host equipment with the first local area communication network according to claim 15.

18. A system for managing a request for activating at least one interface with at least one second local area communication network of an item of host equipment by an item of terminal equipment, the item of host equipment being configured to manage a first local area communication network and to connect to a second local area communication network, the item of host equipment comprising at least one interface with the first network, the item of host equipment, the at least one interface being in standby mode, and at least one interface that has remained active with the second local network, wherein the system comprises the host equipment according to claim 16 and the terminal equipment, the terminal equipment being configured to connect to the item of host equipment configured to manage at the first local area communication network and the second local area communication network, the item of host equipment being in standby mode, wherein the terminal equipment comprises a first device for requesting activation of the at least one interface of the item of host equipment with the first local area communication network according to a second device for requesting to activate at least one interface of the item of host equipment with the first local area communication network managed by the item of host equipment, the item of host equipment and the at least one interface being in standby mode, wherein the second device is configured to:
send to the item of host equipment an application message requesting activation of the at least one interface of the first network on an interface that has remained active of the item of host equipment with the second local area communication network;
upon detection of the first network, send a connection request to the interface; and
execute a service using the connection to the first network.
